(19) United States
(12) Patent Application Publication
(10) Pub. No.: US 2020/0210811 A1
(43) Pub. Date: Jul. 2, 2020

(54) DATA PROCESSING METHOD BASED ON NEURAL NETWORK, TRAINING METHOD OF NEURAL NETWORK, AND APPARATUSES THEREOF

(71) Applicant: Samsung Electronics Co., Ltd., Suwon-si (KR)

(72) Inventors: Jahoo KOO, Seoul (KR); Dae Hyun JI, Hwaseong-si (KR); Yoonsuk HYUN, Suwon-si (KR)

(73) Assignee: Samsung Electronics Co., Ltd., Suwon-si (KR)

(21) Appl. No.: 16/553,466

(22) Filed: Aug. 28, 2019

(30) Foreign Application Priority Data
Dec. 26, 2018 (KR) 10-2018-0169167

(51) Int. Cl. G06N 3/04; G06K 9/62

(52) U.S. Cl. CPC G06N 3/0454; G06K 9/6267; G06N 3/0481

(57) ABSTRACT

Provided is a method of processing data based on a neural network, the method including receiving input data; determining a hyper parameter of a first neural network that affects at least one of a speed of the first neural network and an accuracy of the first neural network by processing the input data based on a second neural network; and processing the input data based on the hyper parameter and the first neural network.

### CROSS-REFERENCE TO RELATED APPLICATIONS

This application claims the benefit under 35 USC § 119(a) of Korean Patent Application No. 10-2018-0169167 filed on Dec. 26, 2018 in the Korean Intellectual Property Office, the entire disclosure of which is incorporated herein by reference for all purposes.

### BACKGROUND

### 1. Field

The following description relates to a method of processing data based on a neural network, a method of training the neural network, and apparatuses thereof.

### 2. Description of Related Art

Research is being actively conducted to classify input patterns in groups so that efficient pattern recognition may be performed on computers. This includes research on an artificial neural network (ANN) that is obtained by modeling pattern recognition characteristics using by mathematical expressions. The ANN may employ an algorithm that mimics abilities to learn. The ANN generates mapping between input patterns and output patterns using the algorithm, and a capability of generating the mapping is expressed as a learning capability of the ANN. Also, the ANN has a capability to generate a relatively correct output with respect to an input pattern that has not been used for training based on a result of previous training. Various types of data may be processed using ANN. Some deep learning based ANNs perform an inference process to acquire a result, which leads to using a relatively large amount of time and may be difficult to operate in real-time. A region proposal based neural network may not correct a number of initially set regions of interest (ROIs) regardless of the data that is input. Accordingly, it is difficult to adjust a number of ROIs to be proposed based on a difficulty of an image or to adaptively adjust an amount of computation time or a level of computation difficulty.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of processing data based on a neural network, the method including receiving input data, determining a hyper parameter of a first neural network that affects at least one of a speed of the first neural network or an accuracy of the first neural network by processing the input data based on a second neural network, and processing the input data based on the hyper parameter and the first neural network.

The first neural network may include at least one of a region proposal network configured to detect regions corresponding to an object in the input data using a desired number of proposed regions, or a classification network configured to classify the object.

The second neural network may include a reinforcement learning network configured to variably set the hyper parameter based on a reward corresponding to a result of processing from the first neural network.

The hyper parameter may include at least one of a number of proposed regions for a region proposal network of the first neural network that affects the speed of the first neural network and the accuracy of the first neural network, or a detection threshold for a classification network of the first neural network that affects the accuracy of the first neural network.

The second neural network may be trained by applying a reward that may be determined based on previous input data.

The processing of the input data based on the hyper parameter and the first neural network may include changing a first number of proposed regions in the first neural network with a second number of proposed regions according to the hyper parameter, detecting regions corresponding to at least one object in the input data based on the second number of regions, changing a first detection threshold to classify the at least one object detected in the first neural network with a second detection threshold according to the hyper parameter, and classifying the at least one object based on the second detection threshold.

In another general aspect, there is provided a method of training a neural network, the method including acquiring learning data and a label corresponding to the learning data, determining a hyper parameter of a first neural network that affects at least one of a speed of the first neural network or an accuracy of the first neural network by processing the learning data based on a second neural network, processing the learning data based on the hyper parameter and the first neural network, determining a reward for variably setting the hyper parameter based on a result of comparing a processing result of the learning data and the label, and training the second neural network by applying the reward.

The determining of the reward may include determining whether the processing result of the learning data is a wrong answer or a correct answer based on comparing the processing result of the learning data and the label, and determining the reward based on the result of the processing being the wrong answer or the correct answer.

The determining of whether the processing result is the wrong answer or the correct answer may include computing a correct answer rate based on the result of comparing the processing result of learning data and the label, and determining whether the processing result is the wrong answer or the correct answer depending on whether the correct answer rate is greater than a detection threshold.

The determining of the reward may include determining the reward to increase a number of proposed regions for a region proposal network of the first neural network and to decrease a detection threshold for a classification network of the first neural network in the hyper parameter, in response to the processing result being the wrong answer.

The determining of the reward may include determining the reward to decrease a number of proposed regions for a region proposal network of the first neural network and to increase a detection threshold for a classification network of the first neural network in the hyper parameter, in response to the processing result being the correct answer.

The hyper parameter may include at least one of a number of proposed regions for a region proposal network of the first neural network that affects the speed of the neural network and the accuracy of the first neural network, or a detection threshold for a classification network of the first neural network that affects the accuracy of the first neural network.

The determining of the hyper parameter may include determining the hyper parameter of the first neural network by applying the learning data to the second neural network that may be trained by applying another reward that may be determined based on previous learning data.

The processing of the learning data based on the hyper parameter and the first neural network may include changing a first number of proposed regions in the first neural network with a second number of proposed regions according to the hyper parameter, detecting regions corresponding to an object in the learning data based on the second number of regions, changing a first detection threshold to classify the object detected in the first neural network with a second detection threshold according to the hyper parameter, and classifying the object based on the second detection threshold.

In another general aspect, there is provided an apparatus for processing data based on a neural network, the apparatus including a communication interface configured to receive input data, and a processor configured to determine a hyper parameter of a first neural network that affects at least one of a speed of the first neural network or an accuracy of the first neural network by processing the input data based on a second neural network, and process the input data based on the hyper parameter and the first neural network.

The first neural network may include at least one of a region proposal network configured to detect regions corresponding to an one object in the input data using a desired number of proposed regions, or a classification network configured to classify the object.

The second neural network may include a reinforcement learning network configured to variably set the hyper parameter based on a reward corresponding to a result of the processing from the first neural network.

The hyper parameter may include at least one of a number of proposed regions for a region proposal network of the first neural network that affects the speed of the first neural network and the accuracy of the first neural network, and a detection threshold for a classification network of the first neural network that affects the accuracy of the first neural network.

The second neural network may be trained by applying a reward that may be determined based on previous input data.

The processor may be configured to change a first number of proposed regions in the first neural network with a second number of proposed regions according to the hyper parameter, detect regions corresponding to at least one object in the input data based on the second number of regions, change a first detection threshold to classify the at least one object detected in the first neural network with a second detection threshold according to the hyper parameter, and classify the at least one object based on the second detection threshold.

In another general aspect, there is provided an apparatus for training a neural network, the apparatus including a communication interface configured to acquire learning data and a label corresponding to the learning data, and a processor configured to determine a hyper parameter of a first neural network that affects at least one of a speed of the first neural network or an accuracy of the first neural network by processing the learning data based on a second neural network, process the learning data based on the hyper parameter and the first neural network, determine a reward for variably setting the hyper parameter based on a result of comparing a processing result of the learning data and the label, and train the second neural network by applying the reward.

The processor may be configured to determine whether the processing result of the learning data is a wrong answer or a correct answer based on comparing the processing result of the learning data and the label, and to determine the reward based on the result of the processing being the wrong answer or the correct answer.

The processor may be configured to compute a correct answer rate based on the result of comparing the processing result of learning data and the label, and to determine whether the processing result is the wrong answer or the correct answer depending on whether the correct answer rate is greater than a detection threshold.

The processor may be configured to determine the reward to increase a number of proposed regions for a region proposal network of the first neural network and to decrease a detection threshold for a classification network of the first neural network in the hyper parameter, in response to the processing result being the wrong answer.

The processor may be configured to determine the reward to decrease a number of proposed regions for a region proposal network of the first neural network and to increase a detection threshold for a classification network of the first neural network in the hyper parameter, in response to the processing result being the correct answer.

The hyper parameter may include at least one of a number of proposed regions for a region proposal network of the first neural network that affects the speed of the neural network and the accuracy of the first neural network, or a detection threshold for a classification network of the first neural network that affects the accuracy of the first neural network.

The processor may be configured to determine the hyper parameter of the first neural network by applying the learning data to the second neural network that may be trained by applying another reward that may be determined based on previous learning data.

The processor may be configured to change a first number of proposed regions in the first neural network with a second number of proposed regions according to the hyper parameter, detect regions corresponding to an object in the learning data based on the second number of regions, change a first detection threshold to classify the object detected in the first neural network with a second detection threshold according to the hyper parameter, and classify the object based on the second detection threshold.

Other features and aspects will be apparent from the following detailed description, the drawings, and the claims.

### BRIEF DESCRIPTION OF THE DRAWINGS

FIG. 1 illustrates an example of a structure and an operation of an apparatus for processing data based on a neural network.

FIG. 2 illustrates an example of a structure and an operation of a first neural network.

FIG. 3 is a diagram illustrating an example of a method of processing data based on a neural network.

FIG. 4 illustrates an example of a structure and an operation of an apparatus for training a neural network.

FIG. 5 is a diagram illustrating an example of a method of training a neural network.

FIGS. 6A and 6B illustrate examples of a method of determining a reward.

FIG. 7 illustrates an example of an apparatus for processing data based on a neural network.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, except for operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

The terminology used herein is for the purpose of describing particular examples only and is not to be limiting of the examples. As used herein, the singular forms “a”, “an”, and “the” are intended to include the plural forms as well, unless the context clearly indicates otherwise.

When a part is connected to another part, it includes not only a case where the part is directly connected but also a case where the part is connected with another part in between. Also, when a part includes a constituent element, other elements may also be included in the part, instead of the other elements being excluded, unless specifically stated otherwise. Although terms such as “first,” “second,” “third” “A,” “B,” (a), and (b) may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

As used herein, the singular forms are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The use of the term ‘may’ herein with respect to an example or embodiment, e.g., as to what an example or embodiment may include or implement, means that at least one example or embodiment exists where such a feature is included or implemented while all examples and embodiments are not limited thereto.

Hereinafter, the examples are described with reference to the accompanying drawings. Like reference numerals used in the drawings refer to like components throughout although they are illustrated in the different drawings.

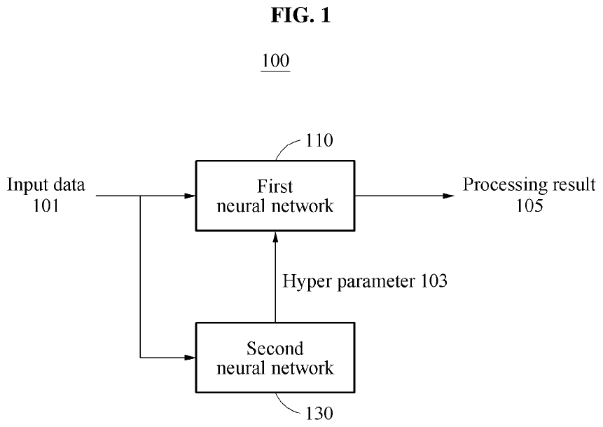

FIG. 1 illustrates an example of a structure and an operation of an apparatus (also, referred to as a data processing apparatus) for processing data based on a neural network. FIG. 1 illustrates a data processing apparatus 100 that includes a first neural network 110 and a second neural network 130.

In an example, the first neural network 110 and the second neural network 130 may correspond to a recurrent neural network (RNN) or a convolutional neural network (CNN). In an example, the CNN may be a deep neural network (DNN). Ain an example, the DNN may include a region proposal network (RPN), a classification network, a reinforcement learning network, a fully-connected network (FCN), a deep convolutional network (DCN), a long-short term memory (LSTM) network, and a grated recurrent units (GRUs). The DNN may include a plurality of layers. The plurality of layers may include an input layer, at least one hidden layer, and an output layer. In an example, neural network may include a sub-sampling layer, a pooling layer, a fully connected layer, etc., in addition to a convolution layer.

The first neural network 110 and the second neural network 130 may map input data and output data that have a nonlinear relationship based on deep learning to perform tasks such as, for example, object classification, object recognition, audio or speech recognition, and image recognition.

The first neural network 110 and the second neural network 130 may be trained to perform a desired operation by mapping input data and output data that have a nonlinear relationship therebetween through deep learning to perform tasks such as, for example, object classification, object recognition, audio or speech recognition, and image recognition. The deep learning is a machine learning method used to solve a problem given from a big dataset. The deep learning may also be construed as a problem-solving process for optimization to find a point where energy is minimized while training the neural network using provided training data. Through the deep learning, for example, supervised or unsupervised learning, a weight corresponding to an architecture or a model of the neural network may be obtained, and the input data and the output data may be mapped to each other based on the obtained weight.

In an example, the first neural network 110 and the second neural network 130 may be implemented as an architecture having a plurality of layers including an input image, feature maps, and an output. In the first neural network 110 and the second neural network 130, a convolution operation between the input image, and a filter referred to as a kernel, is performed, and as a result of the convolution operation, the feature maps are output. Here, the feature maps that are output are input feature maps, and a convolution operation between the output feature maps and the kernel is performed again, and as a result, new feature maps are output. Based on such repeatedly performed convolution operations, results of recognition of characteristics of the input image via the neural network may be output.

In another example, the first neural network 110 and the second neural network 130 may include an input source sentence, (e.g., voice entry) instead of an input image. In such an example, a convolution operation is performed on the input source sentence with a kernel, and as a result, the feature maps are output. The convolution operation is performed again on the output feature maps as input feature maps, with a kernel, and new feature maps are output. When the convolution operation is repeatedly performed as such, a recognition result with respect to features of the input source sentence may be finally output through the neural network.

Input data 101 may be input to all of the first neural network 110 and the second neural network 130. For example, the input data 101 may include image data, voice data, and text data. However, they are provided as examples only, and other types of data may be input without departing from the spirit and scope of the illustrative examples described.

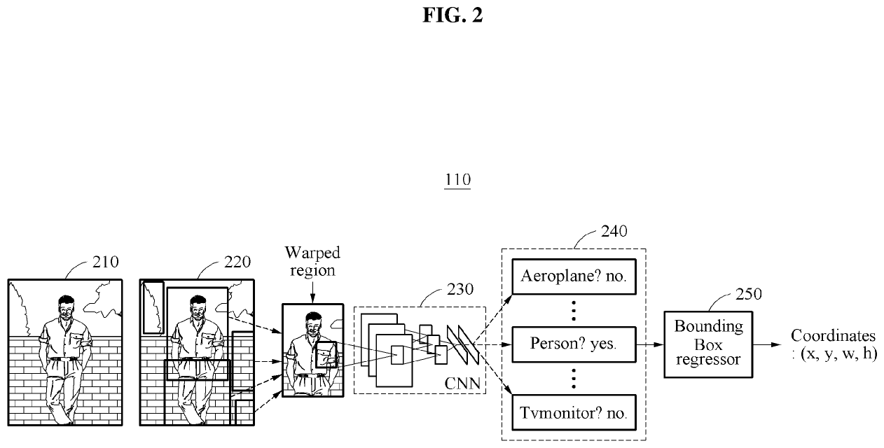

In an example, the first neural network 110 may include, for example, a region proposal network (RPN) and a classification network. The regional proposal network may detect regions corresponding to at least one object included in the input data 101 using a number of proposed regions. The classification network may detect and/or classify the at least one object detected by the regional proposal network. The classification network may be, for example, a detector and a classifier. An example of a structure and an operation of the first neural network 110 will be described with reference to FIG. 2.

In an example, the second neural network 130 variably sets a hyper parameter 103 based on a reward that is determined based on a processing result 105 of the first neural network 110. The second neural network 130 may include, for example, a reinforcement learning network. Dissimilar to supervised learning, output for a given input, that is, ground truth is not provided to the reinforcement learning network. Instead, in the reinforcement learning, a reward is given with respect to a result of series of actions and a neural network is trained using the reward. The reinforcement learning network may be applied to perform an action corresponding to a given input, such as, for example, a robot or a game player.

The input data 101 is processed in the first neural network 110 based on the hyper parameter 103 that is transmitted from the second neural network 130 and output as the processing result 105 of the data processing apparatus 100. In an example, the hyper parameter 103 may be a hyper parameter of the first neural network 110 that affects at least one of, for example, a speed of the first neural network 110 and an accuracy of the first neural network 110. The hyper parameter 103 may include, for example, a number of proposed regions for the regional proposal network of the first neural network 110 that affects the speed of the first neural network 110 and the accuracy of the first neural network 110, and a detection threshold for the classification network of the first neural network 110 that affects the accuracy of the first neural network 110. Depending on examples, the hyper parameter 103 may further include an aspect ratio of each of candidate regions and a size of each of the proposed regions in the first neural network 110.

In an example, the second neural network 130 may be trained by applying a reward determined in response to previous input data of the input data 101. For example, when the input data 101 refers to data that is input to the data processing apparatus 100 at a time t, the previous input data may be data that is input to the data processing apparatus 100 at a time t-1.

When the input data 101 is applied, the second neural network 130 determines the hyper parameter 103 based on the reward that is a learning result of the previous input data and transmits the determined hyper parameter 103 to the first neural network 110.

In an example, the first neural network 110 may change the number of proposed regions for the regional proposal network of the first neural network 110 based on the hyper parameter 103. For example, the first neural network 110 may change the number, for example, 3, of proposed regions for the regional proposal network of the first neural network 110 with the number, for example, 5 or 2, of proposed regions based on the hyper parameter 103. In an example, the first neural network 110 may detect the plurality of regions corresponding to the at least one object included in the input data 101 based on the changed number of regions.

The first neural network 110 may change the detection threshold, for example, 0.7, set to classify the at least one object detected in the classification network of the first neural network 110 with a detection threshold, for example, 0.65 or 0.8, according to the hyper parameter 103. The first neural network 110 may classify at least one object from the plurality of regions based on the changed detection threshold.

For example, in response to increasing the number of proposed regions in the regional proposal network, it is possible to further accurately detect an object to be retrieved. However, a processing load and a processing rate may be degraded due to an increase in the number of candidate regions. Also, if the detection threshold is high, the detection accuracy of the first neural network 110 may be enhanced, however, a detection rate may be degraded.

In an example, both an operation time and performance of the first neural network 110 may be enhanced by variably setting the hyper parameter 103 using the second neural network 130. In an example, the data processing apparatus 100 may enhance the processing load and the processing rate of the first neural network 110 by minimizing the number of proposed regions based on the hyper parameter 103 that is provided from the second neural network 130. In an example, the data processing apparatus 100 may enhance a correct answer rate, that is, the accuracy of the first neural network 110, by optimizing the detection threshold for the detected object.

FIG. 2 illustrates an example of a structure and an operation of a first neural network. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. One or more blocks of FIG. 2, and combinations of the blocks, can be implemented by special purpose hardware-based computer, such as a processor, that perform the specified functions, or combinations of special purpose hardware and computer instructions. In addition to the description of FIG. 2 below, the descriptions of FIG. 1 are also applicable to FIG. 2 and are incorporated herein by reference. Thus, the above description may not be repeated here.

In operation 210, the first neural network 110 receives an input image. In operation 220, in response to receiving the input image, the first neural network 110 extracts a desired number of regions or proposed regions from the input image. In operation 230, the first neural network 110 extracts a feature from the regions using, for example, convolution layers and generates a feature map. Operations 210 to 230 may be performed through the aforementioned regional proposal network.

In operations 240 and 250, the first neural network 110 performs a classification and a regression based on the feature map. In operation 240, the first neural network 110 performs the classification of cutting the proposed regions and classifying classes of the corresponding regions. When performing the classification in operation 240, the first neural network 110 computes a confidence score regarding whether each of the proposed regions fits a specific class and determines the corresponding proposed region as the specific class when the confidence score exceeds a threshold. In operation 250, the first neural network 110 performs the regression based on a bounding box regressor configured to precisely control a position of a bounding box for classifying a boundary between the corresponding regions. Operations 240 and 250 may be performed by the aforementioned classification network.

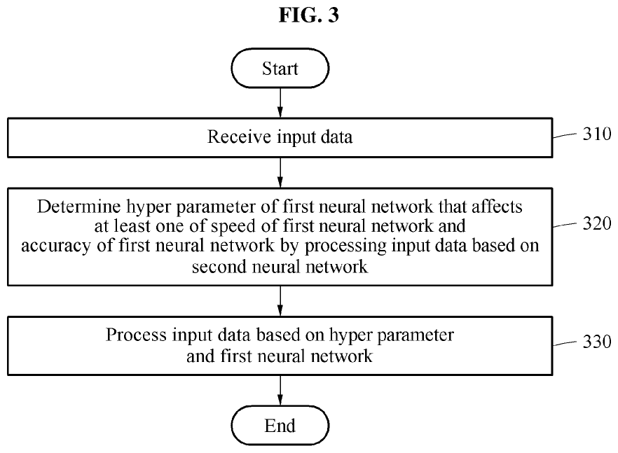

FIG. 3 is a diagram illustrating an example of a method of processing data based on a neural network. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. One or more blocks of FIG. 3, and combinations of the blocks, can be implemented by special purpose hardware-based computer, such as a processor, that perform the specified functions, or combinations of special purpose hardware and computer instructions. In addition to the description of FIG. 3 below, the descriptions of FIGS. 1-2 are also applicable to FIG. 3 and are incorporated herein by reference. Thus, the above description may not be repeated here.

Referring to FIG. 3, in operation 310, the data processing apparatus receives input data. The input data may be, for example, image data, voice data, and text data.

In operation 320, the data processing apparatus determines a hyper parameter of a first neural network that affects at least one of a speed of the first neural network and an accuracy of the first neural network by processing the input data based on a second neural network. For example, the data processing apparatus may determine the hyper parameter of the first neural network by applying the input data to the second neural network that is trained by applying a reward that is determined based on previous input data.

In operation 330, the data processing apparatus processes the input data based on the hyper parameter and the first neural network. In an example, the data processing apparatus may change a number of proposed regions in the first neural network with a number of proposed regions according to the hyper parameter. The data processing apparatus may detect a plurality of regions corresponding to at least one object included in the input data based on the changed number of regions. The data processing apparatus may change a detection threshold set to classify at least one object detected in the first neural network with a detection threshold according to the hyper parameter.

The data processing apparatus may classify the at least one object based on the changed detection threshold.

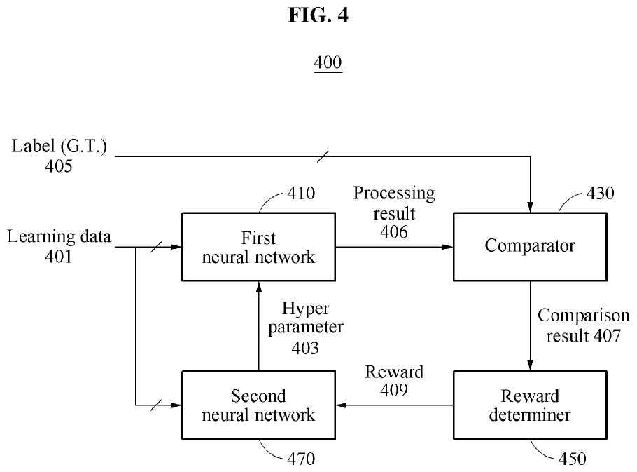

FIG. 4 illustrates an example of a structure and an operation of an apparatus for training a neural network. Referring to FIG. 4, a neural network training apparatus 400 includes a first neural network 410, a comparator 430, a reward determiner 450, and a second neural network 470.

When learning data 401 is input, the first neural network 410 processes the learning data 401 by performing a region proposal and a classification and outputs a processing result 406. The learning data 401 may include a single piece of data or a plurality of pieces of data, for example, sequential image frames. The first neural network 410 processes the learning data 401 based on a hyper parameter 403 that is determined by the second neural network 470 and outputs the processing result 406. Here, the hyper parameter 403 is determined by the second neural network 470 that is trained by applying a reward 409 that is determined based on previous learning data.

For example, the processing result 406 may include a result of detecting an object included in the learning data 401. In detail, the processing result 406 may include a number of objects included in the learning data 401, classes of the objects, and positions of the objects.

The comparator 430 receives a label 405, for example, ground truth (G.T.), corresponding to the learning data 401 and the processing result 406 of the first neural network 410. A number of labels 405 corresponding to the learning data 401 may correspond to a number of pieces of the learning data 401, and may be singular or plural.

The comparator 430 compares the label 405 to the processing result 406 of the first neural network 410 and outputs a comparison result 407 regarding whether the processing result 406 of the first neural network 410 is correct or wrong. The comparator 430 may output, for example, a correct answer or a wrong answer, or may output a first logic value of, for example, ‘0’, or a second logic value of, for example, ‘1’.

The processing result 407 output from the comparator 430 is input to the reward determiner 450.

The reward determiner 450 determines the reward 409 corresponding to a current number of iterations or a current number of trainings based on the comparison result 407. Here, the reward 409 is used for the second neural network 470 to variably set the hyper parameter 403 of the first neural network 410.

For example, when the comparison result 407 of the comparator 430 corresponding to the learning data 401 is a correct answer, the reward determiner 450 determines that the learning data 401 is data corresponding to a relatively low processing difficulty or data from which an object is easily detected. In response to processing data of the low processing difficulty, the reward determiner 450 determines the reward 409 to decrease a number of proposed regions that is determined for the first neural network 410 and to increase a detection threshold. The reward determiner 450 determines the reward 409 to enhance a performance rate of the first neural network 410 by decreasing the number of proposed regions and to enhance an accuracy by increasing the detection threshold.

In another example, when the comparison result 407 of the comparator 430 corresponding to the learning data 401 is a wrong answer, the reward determiner 450 determines that the learning data 401 is data corresponding to a relatively high processing difficulty or data from which an object is not readily detected. In response to processing data of the high processing difficulty, the reward determiner 450 determines the reward 409 to increase the number of proposed regions that is determined for the first neural network 410 and to decrease the detection threshold. The reward determiner 450 determines the reward 409 to enhance the detection accuracy of the first neural network 410 by increasing the number of proposed regions and to decrease the detection difficulty by decreasing the detection threshold.

The neural network training apparatus 400 trains the second neural network 470 by applying the reward 409.

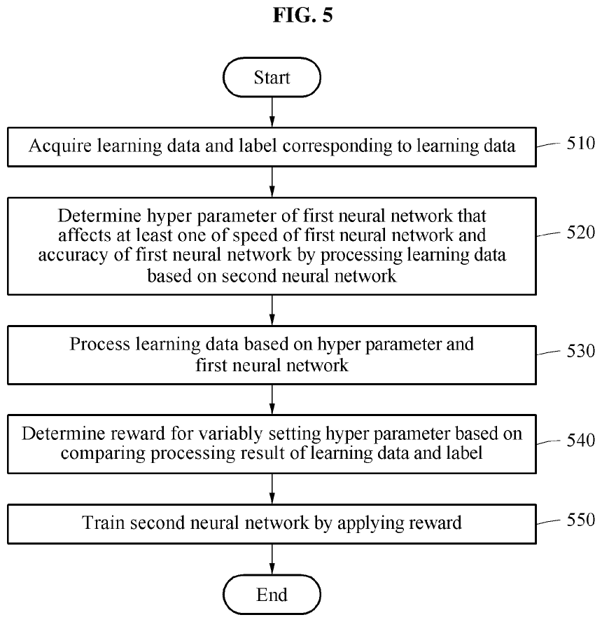

FIG. 5 is a diagram illustrating an example of a neural network training method. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. One or more blocks of FIG. 5, and combinations of the blocks, can be implemented by special purpose hardware-based computer, such as a processor, that perform the specified functions, or combinations of special purpose hardware and computer instructions. In addition to the description of FIG. 5 below, the descriptions of FIGS. 1-4 are also applicable to FIG. 5 and are incorporated herein by reference. Thus, the above description may not be repeated here.

Referring to FIG. 5, in operation 510, a training apparatus acquires learning data and a label corresponding to the learning data.

In operation 520, the training apparatus determines a hyper parameter of a first neural network that affects at least one of a speed of the first neural network and an accuracy of the first neural network by processing the learning data based on a second neural network. The training apparatus may determine the hyper parameter of the first neural network by applying the learning data to the second neural network that is trained by applying a reward that is determined based on previous learning data.

In operation 530, the training apparatus processes the learning data based on the hyper parameter and the first neural network. In operation 530, in an example, the training apparatus changes a number of proposed regions in the first neural network with a number of proposed regions according to the hyper parameter. The training apparatus detects a plurality of regions corresponding to at least one object included in the learning data based on the changed number of regions. In an example, the training apparatus changes a detection threshold set to classify at least one object detected in the first neural network with a detection threshold according to the hyper parameter. The training apparatus classifies the at least one object based on the changed detection threshold.

In operation 540, the training apparatus determines a reward for variably setting the hyper parameter based on a result of comparing a processing result of the learning data and the label. The training apparatus may determine whether the processing result of the learning data is a wrong answer or a correct answer based on the result of comparing the processing result of the learning data and the label. In an example, the training apparatus may compute a correct answer rate based on the result of comparing the processing result of learning data and the label, and may determine whether the processing result is the wrong answer or the correct answer depending on whether the correct answer rate is greater than a detection threshold.

The training apparatus may determine the reward based on the result of determining whether the processing result is the wrong answer or the correct answer. For example, when the processing result is determined to be the wrong answer, the training apparatus determines the reward to increase the number of proposed regions for a region proposal network of the first neural network and to decrease a detection threshold for a classification network of the first neural network in the hyper parameter. In another example, when the processing result is determined to be the correct answer, the training apparatus determines the reward to decrease the number of proposed regions for the region proposal network of the first neural network and to increase the detection threshold for the classification network of the first neural network in the hyper parameter.

In operation 550, the training apparatus trains the second neural network by applying the reward.

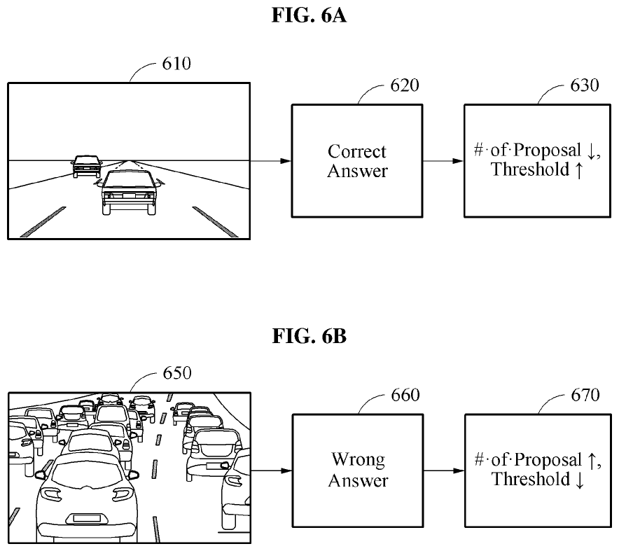

FIGS. 6A and 6B illustrate examples of a method of determining a reward. FIG. 6A illustrates an example of a method of determining, by a neural network training apparatus, a reward when a comparison result between a processing result of learning data 610 and a label corresponding to the learning data 610 is a correct answer 620.

Referring to FIG. 6A, when the comparison result is the correct answer 620, the neural network training apparatus determines the reward to enhance a performance rate of a first neural network by decreasing a number of proposed regions for an regional proposal network of a first neural network and to enhance the accuracy by increasing a detection threshold for a classification network of the first neural network as shown in a box 630.

FIG. 6B illustrates an example of a method of determining, by the neural network training apparatus, a reward when a comparison result between a processing result of learning data 650 and a label corresponding to the learning data 650 is a wrong answer 660.

Referring to FIG. 6B, when the comparison result is the wrong answer 660, the neural network training apparatus determines the reward to enhance the detection accuracy of the first neural network by increasing the number of proposed regions for the regional proposal network of the first neural network and to decrease the detection difficulty by decreasing the detection threshold for the classification network of the first neural network.

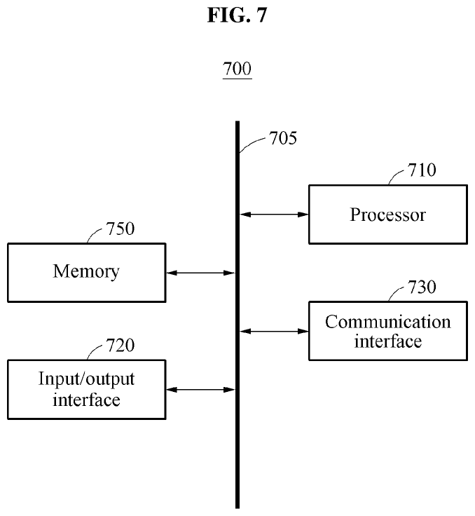

FIG. 7 illustrates an example of an apparatus for processing data based on a neural network. Referring to FIG. 7, a data processing apparatus 700 includes a processor 710, an input/output interface 720, a communication interface 730, a memory 750. The processor 710, the communication interface 730, and the memory 750 may communicate with each other through a communication bus 705.

The processor 710 determines a hyper parameter of a first neural network that affects at least one of a speed of the first neural network and an accuracy of the first neural network by processing the input data based on a second neural network. The processor 710 processes the input data based on the hyper parameter and the first neural network. Further details regarding the process 710 is provided below.

The communication interface 730 receives the input data. In an example, the communication interface receives the input data from the input/output interface 720.

Also, the processor 710 may perform at least one method described above with reference to FIGS. 1 to 6 and an algorithm corresponding to the at least one method. The processor 710 may be a data processing device configured as hardware having a circuit in a physical structure to implement desired operations. For example, the desired operations may include codes or instructions included in a program. For example, the data processing device configured as hardware may include a microprocessor, a central processing unit (CPU), a processor core, a multicore processor, a reconfigurable processor, a multiprocessor, an application-specific integrated circuit (ASIC), a field programmable gate array (FPGA), a graphics processor unit (GPU), or any other type of multi- or single-processor configuration.

The processor 710 executes the program and controls the data processing apparatus 700. A code of the program executed by the processor 710 may be stored in the memory 750.

In an example, the input/output interface 720 may be a display that receives an input from a user or provides an output. In an example, the input/output interface 720 may function as an input device and receives an input from a user through a traditional input method, for example, a keyboard and a mouse, and a new input method, for example, a touch input, a voice input, and an image input. Thus, the input/output interface 720 may include, for example, a keyboard, a mouse, a touchscreen, a microphone, and other devices that may detect an input from a user and transmit the detected input to the data processing apparatus 700.

In an example, the input/output interface 720 may function as an output device, and provide an output of the data processing apparatus 700 to a user through a visual, auditory, or tactile channel. The input/output interface 720 may include, for example, a display, a touchscreen, a speaker, a vibration generator, and other devices that may provide an output to a user.

However, the input/output interface 720 are not limited to the example described above, and any other displays, such as, for example, computer monitor and eye glass display (EGD) that are operatively connected to the data processing apparatus 700 may be used without departing from the spirit and scope of the illustrative examples described. In an example, the input/output interface 720 is a physical structure that includes one or more hardware components that provide the ability to render a user interface, render a display, and/or receive user input.

The memory 750 stores a hyper parameter of a first neural network determined by the processor 710. Also, the memory 750 may store a variety of information generated during the processing process of the processor 710. In addition, the memory 750 may store various types of data and programs. The memory 750 may be a volatile memory or a non-volatile memory. The memory 750 may store a variety of data by including a large mass storage medium, such as a hard disc. Further details regarding the memory 750 is provided below.

The data processing apparatus 100, neural network training apparatus 400, comparator 430, reward determiner 450, data processing apparatus 700, and other apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions or software includes at least one of an applet, a dynamic link library (DLL), middleware, firmware, a device driver, an application program storing the method of processing data based on a neural network or a method of training a neural network. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, card type memory such as multimedia card, secure digital (SD) card, or extreme digital (XD) card, magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing data based on a neural network, the method comprising:
receiving input data;
determining a hyper parameter of a first neural network that affects at least one of a speed of the first neural network or an accuracy of the first neural network by processing the input data based on a second neural network; and
processing the input data based on the hyper parameter and the first neural network.

2. The method of claim 1, wherein the first neural network comprises at least one of a region proposal network configured to detect regions corresponding to an object in the input data using a desired number of proposed regions, or a classification network configured to classify the object.

3. The method of claim 1, wherein the second neural network comprises a reinforcement learning network configured to variably set the hyper parameter based on a reward corresponding to a result of processing from the first neural network.

4. The method of claim 1, wherein the hyper parameter comprises at least one of a number of proposed regions for a region proposal network of the first neural network that affects the speed of the first neural network and the accuracy of the first neural network, or a detection threshold for a classification network of the first neural network that affects the accuracy of the first neural network.

5. The method of claim 1, wherein the second neural network is trained by applying a reward that is determined based on previous input data.

6. The method of claim 1, wherein the processing of the input data based on the hyper parameter and the first neural network comprises:
changing a first number of proposed regions in the first neural network with a second number of proposed regions according to the hyper parameter;
detecting regions corresponding to at least one object in the input data based on the second number of regions;
changing a first detection threshold to classify the at least one object detected in the first neural network with a second detection threshold according to the hyper parameter; and
classifying the at least one object based on the second detection threshold.

7. A non-transitory computer-readable recording medium storing instructions that, when executed by a processor, cause the processor to perform the method of claim 1.

8. A method of training a neural network, the method comprising:
acquiring learning data and a label corresponding to the learning data;
determining a hyper parameter of a first neural network that affects at least one of a speed of the first neural network or an accuracy of the first neural network by processing the learning data based on a second neural network;
processing the learning data based on the hyper parameter and the first neural network;
determining a reward for variably setting the hyper parameter based on a result of comparing a processing result of the learning data and the label; and
training the second neural network by applying the reward.

9. The method of claim 8, wherein the determining of the reward comprises:
determining whether the processing result of the learning data is a wrong answer or a correct answer based on comparing the processing result of the learning data and the label; and
determining the reward based on the result of the processing being the wrong answer or the correct answer.

10. The method of claim 9, wherein the determining of whether the processing result is the wrong answer or the correct answer comprises:
computing a correct answer rate based on the result of comparing the processing result of learning data and the label; and
determining whether the processing result is the wrong answer or the correct answer depending on whether the correct answer rate is greater than a detection threshold.

11. The method of claim 9, wherein the determining of the reward comprises determining the reward to increase a number of proposed regions for a region proposal network of the first neural network and to decrease a detection threshold for a classification network of the first neural network in the hyper parameter, in response to the processing result being the wrong answer.

12. The method of claim 9, wherein the determining of the reward comprises determining the reward to decrease a number of proposed regions for a region proposal network of the first neural network and to increase a detection threshold for a classification network of the first neural network in the hyper parameter, in response to the processing result being the correct answer.

13. The method of claim 8, wherein the hyper parameter comprises at least one of a number of proposed regions for a region proposal network of the first neural network that affects the speed of the neural network and the accuracy of the first neural network, or a detection threshold for a classification network of the first neural network that affects the accuracy of the first neural network.

14. The method of claim 8, wherein the determining of the hyper parameter comprises determining the hyper parameter of the first neural network by applying the learning data to the second neural network that is trained by applying another reward that is determined based on previous learning data.

15. The method of claim 8, wherein the processing of the learning data based on the hyper parameter and the first neural network comprises:
changing a first number of proposed regions in the first neural network with a second number of proposed regions according to the hyper parameter;
detecting regions corresponding to an object in the learning data based on the second number of regions;
changing a first detection threshold to classify the object detected in the first neural network with a second detection threshold according to the hyper parameter; and
classifying the object based on the second detection threshold.

16. An apparatus for processing data based on a neural network, the apparatus comprising:
a communication interface configured to receive input data; and
a processor configured to
determine a hyper parameter of a first neural network that affects at least one of a speed of the first neural network or an accuracy of the first neural network by processing the input data based on a second neural network, and
process the input data based on the hyper parameter and the first neural network.

17. The apparatus of claim 16, wherein the first neural network comprises at least one of a region proposal network configured to detect regions corresponding to an one object in the input data using a desired number of proposed regions, or a classification network configured to classify the object.

18. The apparatus of claim 16, wherein the second neural network comprises a reinforcement learning network configured to variably set the hyper parameter based on a reward corresponding to a result of the processing from the first neural network.

19. The apparatus of claim 16, wherein the hyper parameter comprises at least one of a number of proposed regions for a region proposal network of the first neural network that affects the speed of the first neural network and the accuracy of the first neural network, and a detection threshold for a classification network of the first neural network that affects the accuracy of the first neural network.

20. The apparatus of claim 16, wherein the second neural network is trained by applying a reward that is determined based on previous input data.

21. The apparatus of claim 16, wherein the processor is further configured to:
change a first number of proposed regions in the first neural network with a second number of proposed regions according to the hyper parameter,
detect regions corresponding to at least one object in the input data based on the second number of regions,
change a first detection threshold to classify the at least one object detected in the first neural network with a second detection threshold according to the hyper parameter, and
classify the at least one object based on the second detection threshold.

22. An apparatus for training a neural network, the apparatus comprising:
a communication interface configured to acquire learning data and a label corresponding to the learning data; and
a processor configured to
determine a hyper parameter of a first neural network that affects at least one of a speed of the first neural network or an accuracy of the first neural network by processing the learning data based on a second neural network,
process the learning data based on the hyper parameter and the first neural network,
determine a reward for variably setting the hyper parameter based on a result of comparing a processing result of the learning data and the label, and
train the second neural network by applying the reward.

23. The apparatus of claim 22, wherein the processor is further configured to determine whether the processing result of the learning data is a wrong answer or a correct answer based on comparing the processing result of the learning data and the label, and to determine the reward based on the result of the processing being the wrong answer or the correct answer.

24. The apparatus of claim 23, wherein the processor is further configured to:
compute a correct answer rate based on the result of comparing the processing result of learning data and the label, and to determine whether the processing result is the wrong answer or the correct answer depending on whether the correct answer rate is greater than a detection threshold.

25. The apparatus of claim 23, wherein the processor is further configured to determine the reward to increase a number of proposed regions for a region proposal network of the first neural network and to decrease a detection threshold for a classification network of the first neural network in the hyper parameter, in response to the processing result being the wrong answer.

26. The apparatus of claim 23, wherein the processor is further configured to determine the reward to decrease a number of proposed regions for a region proposal network of the first neural network and to increase a detection threshold for a classification network of the first neural network in the hyper parameter, in response to the processing result being the correct answer.

27. The apparatus of claim 22, wherein the hyper parameter comprises at least one of a number of proposed regions for a region proposal network of the first neural network that affects the speed of the neural network and the accuracy of the first neural network, or a detection threshold for a classification network of the first neural network that affects the accuracy of the first neural network.

28. The apparatus of claim 22, wherein the processor is further configured to determine the hyper parameter of the first neural network by applying the learning data to the second neural network that is trained by applying another reward that is determined based on previous learning data.

29. The apparatus of claim 22, wherein the processor is further configured to:
change a first number of proposed regions in the first neural network with a second number of proposed regions according to the hyper parameter,
detect regions corresponding to an object in the learning data based on the second number of regions,
change a first detection threshold to classify the object detected in the first neural network with a second detection threshold according to the hyper parameter, and
classify the object based on the second detection threshold.
